(19) United States
(12) Patent Application Publication
(10) Pub. No.: US 2019/0272522 A1
(43) Pub. Date: Sep. 5, 2019

(54) PLATFORM AND METHOD FOR TRANSFER OF DIGITAL TOKENS REPRESENTING A BANK'S PROMISE TO PAY BANK ACCOUNT STORED OR CREDIT VALUE

(71) Applicant: Kenneth J. Silverman, Southampton, NY (US)

(72) Inventor: Kenneth J. Silverman, Southampton, NY (US)

(21) Appl. No.: 16/289,410

(22) Filed: Feb. 28, 2019

Related U.S. Application Data
(60) Provisional application No. 62/637,648, filed on Mar. 2, 2018.

(51) Int. Cl. G06Q 20/24; G06Q 20/06; G06Q 20/08

(52) U.S. Cl. CPC G06Q 20/24; G06Q 20/0855; G06Q 20/06

(57) ABSTRACT

A method and system for electronically transferring value from a bank debit account, bank direct line of credit account or bank credit card account is presented, where an electronic representation of a promise is created and the Promisee is transferred, thereby transferring value. In one embodiment, a bank issues one or more digital representations of a promissory note in the form of a digital tokens in response to an action performed by the holder (i.e., Promisee) of a promissory note via an electronic platform. The Promisee can be transferred to a third party recipient, thereby transferring value. Actual funds are transferred only internally within the bank of origin.

### BACKGROUND OF THE INVENTION

This non-provisional patent application is based on provisional patent application Ser. No. 62/637,648 filed Mar. 2, 2018.

### FIELD OF THE INVENTION

The present invention relates to methods and systems of financial bank transactions and, more particularly, to a method and system of software and devices for transferring value from one party to another party where the funds collateralizing the value remain at the bank of origin.

### BRIEF DISCUSSION OF THE RELATED ART

In existing banking systems, value stored in a bank account is just a promise between a bank and a customer or “Promisor” and “Promisee”. The value is represented by an account balance. The balance represents the obligation of the bank (“Promisor”) to pay to the owner (“Promisee”) of that account, any portion of that balance upon demand. Currently, in the banking world, there is no way to transfer that promise to another party. The owner can nullify that promise by withdrawing the value, but not transfer the promise to pay to another party. The value can be withdrawn and hence the promise nullified, in only one of four ways: 1) through the use of a debit card in a payment processor, 2) a check, 3) directly at a bank branch or 4) through electronic access to the debit account such as ACH, eCheck or wire transfer. In all cases, however, value is withdrawn and the promise is nullified.

In no existing incarnation is only the promise transferred to a third party, as opposed to the actual value, so that the third party becomes the Promisee.

In the case of a credit account, the notion is similar but slightly different. When using a credit card account, and after the payment is “processed” by a payment processor, value is transferred from the bank to the new party. The fact that the value was never owned by the originating account holder and the original account holder has a promise to pay the bank after the credit transaction is finished is irrelevant because at no such time was any promise to pay transferred, (no promise to pay the merchant existed before the transaction). And after the transaction, a promise is created from bank to merchant. An additional promise is created between customer and bank immediately after the credit card transaction. At no point is the promise to pay transferred from the customer to the merchant.

Currently, there are two known ways to electronically transfer value of FIAT currency. One is through a bank transfer, bank to bank, the other is through a stable coin transfer, Exchange to electronic wallet (wallet), or wallet to wallet.

Banks transfer debit or credit value in response to a customer action to withdraw or move funds from an existing customer bank account. That action is either a purchase through a debit, credit card or mobile application or via a bank wire, check or e-check.

Stable coin networks transfer value in response to a customer who has either infused cash into an exchange that the stable coin network is sold on, or in response to the trading or swapping through a marketplace or exchange some other type of crypto-currency. The initiating action is only by an event the customer initiates through an online exchange or marketplace that offers the stable coin for sale or trade.

In no case does a stable coin network transfer value as a direct response to a bank customer's request to withdraw, purchase or transfer funds from that customer's bank account, debit account, credit account, or any other account where the customer is storing value or has a credit relationship directly with the bank.

The present invention provides an electronic platform and method for sending of value directly from a bank account (credit or debit account) directly into a cryptographic or other electronic token. It does this through a mechanism of two distinct actions: first, the movement of the funds from the customer account into a bank reserve account; and secondly, the tokenization event which transfers the implied or written promise the bank has with the customer to an electronic promise where the customer is defined by a wallet address and the ability to transfer the Promisee electronically is provided to the customer.

A further distinction between the present invention and stable coin network is that of the sourcing of the reserve pool of funds that collateralize all tokens issued. In both the present invention and stable coin network, the funds backing the tokens issued in response to a customer request for tokens are sourced electronically from a pool of funds the bank itself maintains in a reserve. However, in the case of the stable coin, that reserve is initially sourced by some means that does not come directly from the customer's bank account.

Whereas, in the case of the present invention, the funds in the pool are first sourced directly by value in an established debit or credit bank account of the customer initiating the tokenizing action. That action is also part of the method and devices that transfer the token into the wallet of the customer.

The present invention allows for the transfer of the promise to pay to another Party or the same Party outside of the bank's existing network. Unlike existing banking systems, the present invention does not transfer the value stored, but instead transfers the bank's promise to pay that value to a new Promisee.

The invention further allows for additional transfers of the promise from any current Promisee to future Promisees in an indefinite path until at some point that promise may be delivered back to the bank itself by some future Promisee in exchange for traditional value.

### SUMMARY OF THE INVENTION

Using any electronic ledger (or preferably blockchain, known to those versed in the state of the art), a system and method are provided where through a convenient electronic platform (the platform), such as a ‘Mobile Application’, a bank can issue one or more digital representations of a promissory note in the form of a digital token in the singular and digital tokens in the plural. One digital token represents the obligation to pay one or a fraction or multiple of the unit of the currency the bank does business in, for example, one dollar.

The tokens are issued in response to an action performed by the holder of a promissory note via the platform that exchanges the promise for a token and, at that same time, in one action, the holder of the promise may be changed to a third party, so that the promise to pay is actually transferred to another party.

Because the token represents a promise to pay an exact value, the value of the token is considered “pegged” that value, for example a single dollar.

In the preferred embodiment, the holder of the promise will not change when the token(s) are issued.

But several things are noted in at least one embodiment of the invention:
1) Bank is made aware of desire for token issuance (or transferrance) in the familiar online banking portal of the bank.
2) Transfer is made to a 3^{rd} party network (the platform) in which the holder of the promise prior to token issuance is logged into online banking through the 3^{rd} party network at the time of issuance.
3) 3^{rd} party network has a means to issue tokens on behalf of the bank and hold those tokens on behalf of the holder in such a way that only the holder has control of those tokens in an account on the platform (a digital ‘wallet’). In one embodiment, both for creation of tokens and storage of them in account controlled by the holder is a blockchain-based ledger and wallet respectively, (both known to those versed in the state of the art).
4) Bank is integrated with 3^{rd} party network in a way that the real value store representing the promise before the issuance of the token can be transferred from the bank account of the holder to a reserve account owned by the bank and the 3^{rd} party network can be made aware of that event.
5) Tokens may either be issued (created) at the point of their necessity by promise holder or stored in a bank-owned reserve wallet that is part of the platform and transferred to holder upon demand through online banking portal which interacts both with holder and platform.
6) Preferred: Interaction between online banking and platform may be direct or indirect to a smart contract on the platform (smart contracts are known to those versed in the state of the art of blockchain).

The stored value backing the promise to a holder (Promisee), backs the token at the moment the token is controlled by the holder (upon its issuance or transfer on the platform to the holder)

Advantages of the present invention are numerous and include the following:

### For Debit Accounts

After a debit withdrawal, the bank (Promisor) has no access to the value, neither for collateral for loans from the Federal Reserve or anything else. After a token is issued to holder or transferred to holder under the present invention, however, banks may use the actual value backing the token for collateral for loans, same as it would do before the token issuance. This allows customers of the bank to transact in the real world economy by transferring tokens while the bank still has access to the float on the value backing those tokens.

### For Credit Accounts

Due to the instant nature of token transfer, and the ability to access the token(s) via a convenient mobile application, banks can offer credit accounts direct to their customers, without any credit card company, eliminating the need for both payment processors, credit card companies and any sort of clearing house to “settle” the transaction.

### For Remittance

Due to the fact that the token can change holders many times before eventually or never being returned to the bank, they can be sent from one wallet to another for the purposes of remittance.

### Interchanging Bank Tokens

A decentralized exchange is proposed where tokens of banks emitting different tokens can be exchanged.

### BRIEF DESCRIPTION OF THE DRAWINGS

For a fuller understanding of the nature of the present invention, reference should be made to the following detailed description taken in conjunction with the accompanying drawings in which:

FIG. 1 is a schematic diagram illustrating origination and destination (movement) in a typical electronic transfer of a Promisee from a sender to a recipient party (tXFER);

FIG. 2A is a schematic diagram illustrating an electronic transfer of a Promisee (tXFER) with movement of funds into a reserve account of an originating bank in accordance with the system and method of the present invention;

FIG. 2B is a schematic diagram illustrating tXFER with funds movement into a reserve account of the originating bank and with a Promisee changed to the recipient Promisee (shown here as a merchant) and the promise state recorded on one or more electronic ledgers via a tokenization event, in accordance with the system and method of the present invention;

FIG. 2C is a schematic diagram illustrating the creation of the promise in its electronic state and tXFER with movement into the reserve account and with the Promisee changed to the receiving party using an electronic ledger;

FIG. 3A is a diagram illustrating and describing the redemption process of the system and method of the present invention;

FIG. 3B is a schematic diagram illustrating the entire tXFER flow showing token life cycle, including minting, multiple transfers according to multiple transfers of the Promisee, possible exchange activity and the eventual redemption event wherein the tokens issued by different banks are eventually burned;

FIG. 4 is a schematic diagram illustrating the flow of funds from a central bank or Federal Reserve banks, lending money to other banks;

FIG. 5 is a top plan view illustrating an example of a portable electronic mobile computer device for use in the system and method of the present invention;

FIG. 6 is an illustration of an example QR code used in the system and method of the present invention;

FIG. 7A is a schematic diagram and description showing a suggested embodiment for remittance to a country in a setup where a central bank of that country is the originating bank and its member banks (MSB) are customers in accordance with the system and method of the present invention; and

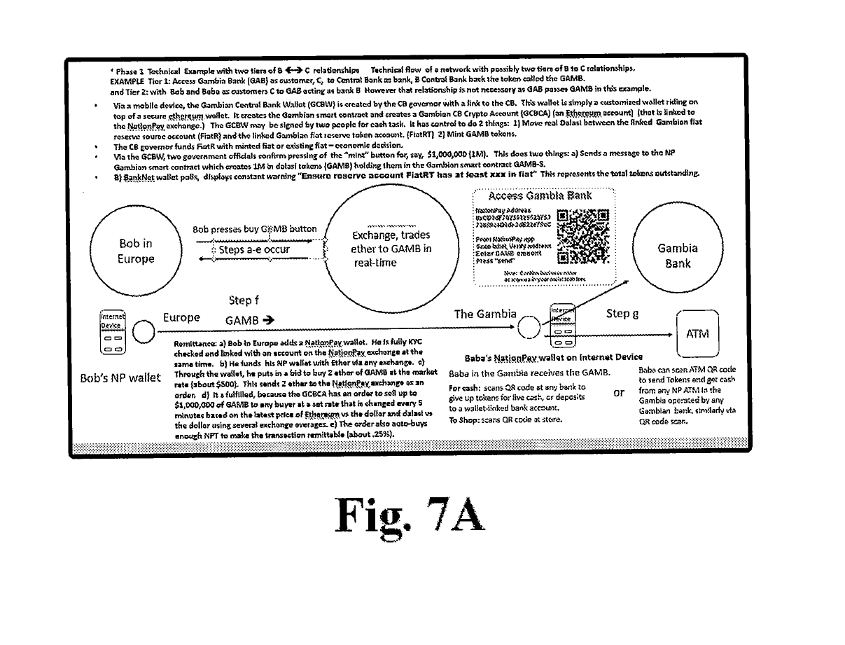

FIG. 7B is a schematic diagram and description of a suggested embodiment for remittance to a country in a setup where the central bank of the country is the originating bank and its member banks are customers, in accordance with the system and method of the present invention.

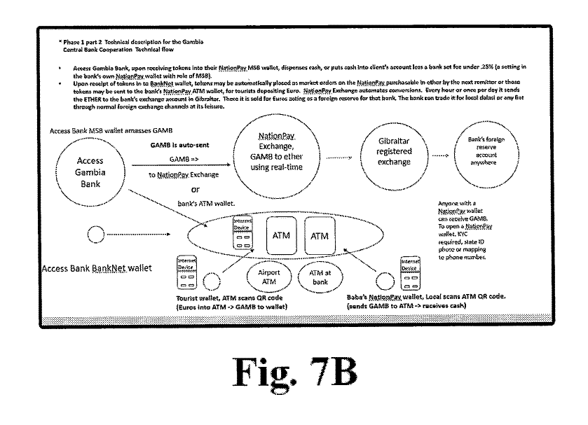

### DETAILED DESCRIPTION OF THE PREFERRED EMBODIMENT

The present invention includes a vehicle (platform), method, bank and device for ‘Transfer’ of ‘Tokens’ using the words ‘promise’, ‘transfer’, ‘token’ and ‘platform’ as defined herein.

A bank is defined as any entity maintaining segregated or comingled currency or credit accounts for individuals, companies, merchants or other entities (Clients or Customers).

A promise is any obligation, a bank has to a Promisee to pay upon demand by the Promisee, some exact real-world currency value as described in the promise. A promise has certain features:

Any current Promisee, and only the current Promisee, may easily transfer his rights to a new Promisee in a manner where nobody may reverse the transfer.

The promise, comprising its obligation for the Promisor (bank) to pay to the Promisee on demand, the ability to transfer the party that is the Promisee, should be backed by a reserve of the exact real currency that is promised, held by the Promisor until some Promisee demands its exchange for actual currency. This is, however, not required for the invention to hold.

A ‘Token’ is defined as the promise, backed by a bank.

A transfer of a token means transferring only the party that is the promissee.

Invention includes a vehicle (Platform) for banks to issue their own Tokens and transfer them to Clients while in the same action, move real currency out of the client account and into the bank reserve account (or if the client account is a credit account, increase the credit amount owed).

The present invention provides an alternative to bank-to-bank transactions. More particularly, the present invention provides a method and a system of software and devices to transfer value where the actual funds collateralizing the value remain at the bank of origin. This is achieved by creating an electronic representation of an already existing or a new promise between the bank and the customer, whereby, once represented electronically, the Promisee can be transferred from the sender to the recipient party electronically. We call the process tXFER. After a tXFER, subsequent transfers necessitate only that the Promisee is transferred, all the while the actual funds backing the promise to pay remain at the bank.

Specifically, a novel means of electronically transferring value from a bank debit account, bank direct line of credit account or bank credit card account is presented, where an electronic representation of a promise is created and the Promisee is transferred, thereby transferring value. Actual funds are transferred only internally within the bank of origin, thus avoiding necessity for external settlement cooperation with other banks, among other benefits.

[Banks include Central Banks and Federal Reserve Banks. Their customers are other banks. The patent includes and covers bank accounts, wherein the owners of those accounts are other banks.]

Today, there is an underlying promise between a bank and its customer, C, wherein a bank allocates certain funds F into an account belonging to C (A), and promises to pay to C (the Promisee) those funds upon demand. Those funds either pertain to a debit account, DA, or a line of credit account, CA. In the case of a DA, the funds are owned by C. Whereas, in the case of a CA, the funds are borrowed by C at the moment immediately preceding or concurrent with the customer transferring those funds to another entity. In both cases however, we can consider these funds F being in a specific account controlled by the customer. C may be any entity, such as a person, company, another bank or any part of B itself as pertains when a bank sends funds to an account of its own internally or at another branch, division or department.

[There is a third type of account, a credit card account CCA. In that case, when C demands funds from B for a purchase, funds are instead initially sourced by a third party credit card company, (CCC) and later reimbursed to the CCC by B. In that case we can consider that the CCC is the bank, B, its customer, C, is the paying bank, and the third party designee, RP, is the receiving bank.]

The promise (P) then, any bank (B) has with customer (C) is that B will pay to C upon demand, funds (F). The demand C has to utilize F is almost always accompanied by the desire to transfer F to a receiving party (RP) rather than to withdraw the funds as cash. RP may be a person or a bank itself or any other corporate entity. RP may also be C. Any bank to which RP is a customer is referred to as the receiving party bank (RPB).

A promise, P, is a contract, implied or written where Bank B (the Promisor) is obligated to pay to the customer C, or to a third party RP, the funds F upon demand. Payment may be made directly to C or on behalf of C to a third party destination.

Any additional obligations, conditions and terms arising out of the creation of P shall be defined as a separate entity called the Appendix to the promise (PAX). Examples of PAX clauses include repayment terms, where C must repay F or some other amount to B. The elements of every promise, P, is the Promisor, B, the Promisee, C, a third party designee RP (which may be C itself) and the funds F promised. RP need not be named until C demands payment, F. (As in, for example, when a credit card is swiped.)

By breaking up the Promise into two components, P and PAX, when payment is made, via any existing form, we declare that P is destroyed, because the only future event P describes, demand payment, will have occurred. However, the PAX continues to exist until its terms are met. Conventional forms of payment include check, e-check, bank wire, card swipe or online card transaction.

Prior to this patent, using all accepted forms of bank payment, there is no provision to electronically transfer the Promisee, C, just the funds, F.

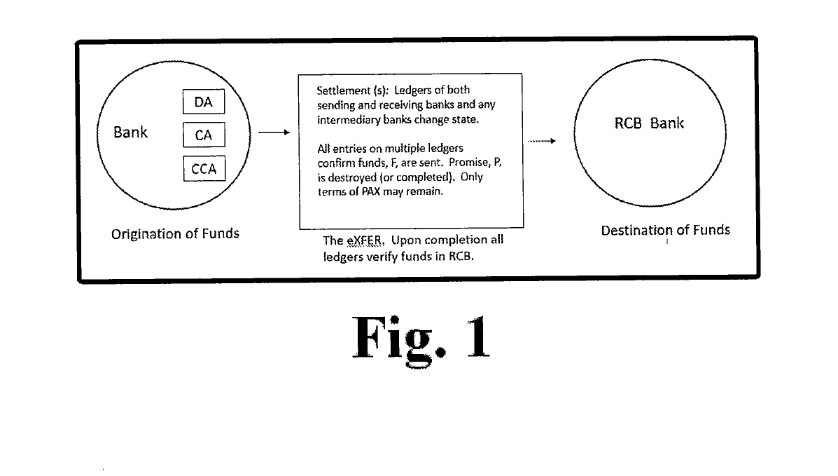

Referring to FIG. 1, the only known methods to make a funds transfer electronically from C to RP (an eXFER) are methods whereby the destination of F is also a bank, and more specifically an RPB. Upon completion, F must be agreed by both sending and receiving banks to be at the receiving RPB. Such agreement is according to electronic ledgers at both B and at the receiving RPB. The process of creating these coordinated ledger entries is called a settlement operation. We define a settlement operation as a series of one or more third party entries to various existing electronic ledgers that verify that the funds have been moved from one bank to another. A settlement operation is further defined by the destruction of the promise between B and C, wherein B is obligated to pay F to C upon demand. (P).

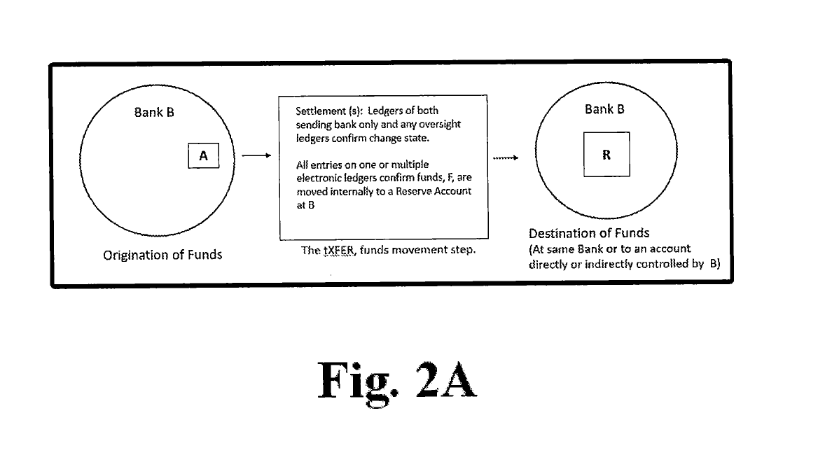

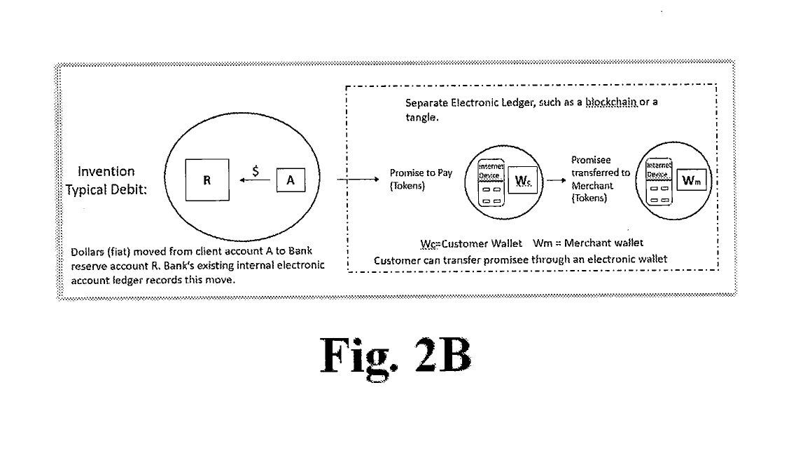

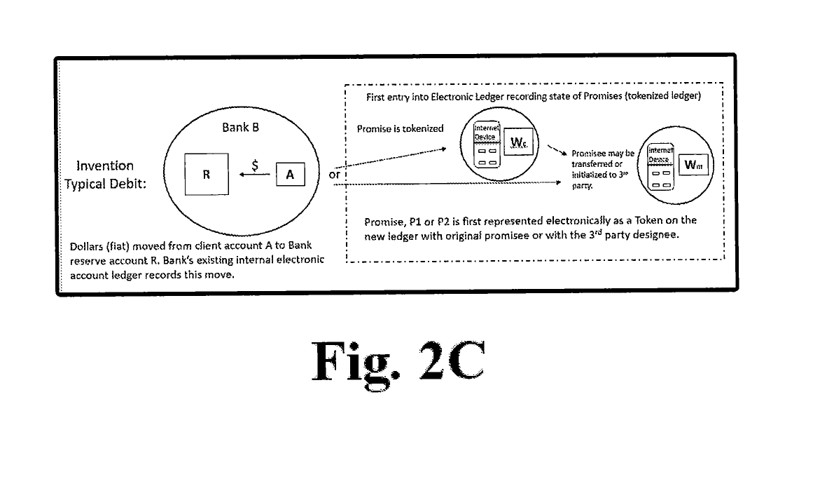

Referring to FIGS. 2A-2B, the present invention proposes that the destination in an eXFER be a reserve account at or controlled by B instead of being an RPB. Herein, the eXFER is also comprised of a second component, namely, that the Promisee, C, immediately preceding the eXFER is transferred to RP as part of or immediately after the eXFER. Thence forth P is recorded electronically and called P1. Alternatively, P may be destroyed and a new promise, P2 may be created as part of the eXFER. In preferred form, P2 is exactly the same as P1. In either case, P1 and P2 are represented electronically as one or more distinct electronic ledger entries, where such entries are made across one or more separate ledgers or occur in any of the same existing internal ledgers of B that record account activity. [We define the electronic representation of P1 or P2 as a series of electronic ledger entries called a tokenization (TK) where a Token (T or Token), represents value such that n times T times F (nTF) Tokens are created (Minted). The portion of the ledger entries describing F (the amount of value promised in P1 or P2) is defined to be equal to that portion of tokens, nTF, where n is defined by some fixed relationship between a single unit of currency in the promise and a single token T. In other words, n is a fixed number that defines how many or what fraction of Tokens are equal to one unit of that currency.] As an example, one token can be defined to be equal in value to one or more ledger entries where the combined promised amounts total to one dollar. The Promisee in P1 or P2 becomes the owner of nTF tokens upon the tokenization event. This type of eXFER with both components (encompassed in FIGS. 2A-2E) is called a tXFER.

Destination of funds according to all ledgers both internal and external confirm funds moved from customer account, A to a reserve account internal to B or otherwise controlled by B.

Thereby, the destination in the eXFER is no longer an external bank, nor is it a bank account belonging to RP. Rather the destination is a separate reserve account at or controlled by B pooling all funds for all tXFERs for any customer of B, not just C. There may be more than one separate R account at any given B apportioning proceeds based on some other characteristic.

### Electronic Ledger and Token Creation

Let a Virtual Account (Wallet) or (W) be that software on any mobile device or computer that organizes an electronic grouping of all Tokens owned by a particular entity. Wm represents a Wallet for all tokens owned by RP. Anyone who can transfer tokens from a particular wallet to another wallet is said to be the owner of that particular wallet. Let W be part of one or more (or a network of) electronic ledgers, collectively called the (TEL) that may or may not be maintained by B. A preferred embodiment of TEL is a blockchain or tangle. (The concept of a wallet as pertains to a blockchain or cryptocurrency ledger, where tokens represent some kind of value, or receipt, is widely known.)

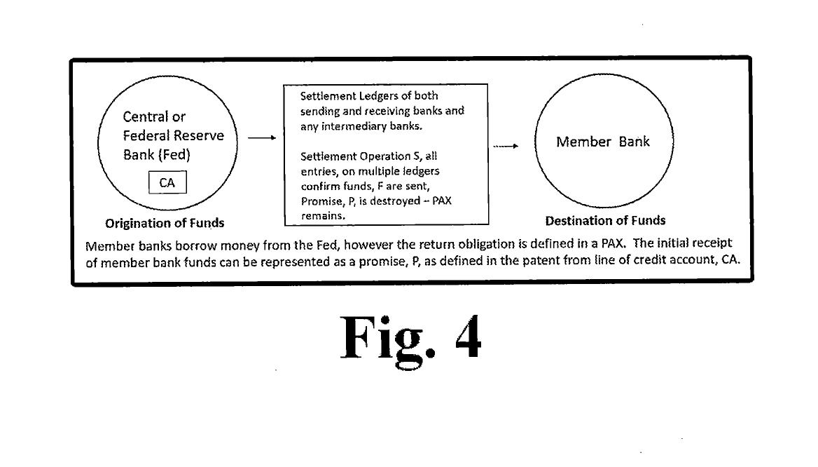

To enable electronic recording of the current state of tokens owned by RP, a TEL is used. The TEL may or may not be managed all or in part by the bank, B. Specifically, the patent claims that to enable recording of token ownership, the tXFER is accompanied by one or more entries in a TEL where it is recorded that RP is the Promisee immediately after the eXFER, and therefore, RP becomes the owner of some quantity of Tokens. Therefore, the transfer of the Promisee, C, is defined, in part, as the transfer of some quantity or fraction of Token(s). The transfer of a Promissee means, in part, that there is a transfer of that same quantity or fraction of Tokens, nTF, representing the total value F in P. See FIG. 4C.

$$Valve ( \begin{matrix}\begin{matrix}Promise , ( P ) implied or written {\text{:} }^{″} Bank B promises \\ to pay to customer , RP , or a designated third party ,\end{matrix} \\ RP 2 , the funds , F , upon demand by RP {.}^{″}\end{matrix} ) = ( nT ) F Tokens$$

$$U = 1 unit of currency , T = n \text{/} u where$$

$$n = pre \text{-} existing fixed number defining how many tokens to a unit .$$

P is represented by some number of TEL entries that refer to a wallet, W, and describe a quantity of tokens, nTF, where n is a fixed number that defines how many tokens are equal to one unit of FIAT currency.

Referring to FIG. 2B tXFER with funds movement into R and with Promisee changed to RP (shown here as Merchant) and the promise state recorded on one or more TEL via a tokenization event. Here, the initial creation of the Promise in its electronic format, (the tokenization event) corresponds to the case where RP is itself C. Then a second transaction on the TEL transfers the Promisee from C to a merchant M.

The TEL may receive an initial set of entries to the original sender as Promisee or with a third party designee as Promisee depending on if the user is sending funds to himself or a third party as the initial promise allows for. See FIG. 2B.

Referring to FIG. 2C, initial creation of the Promise in its electronic state. tXFER with Movement into reserve account and with Promisee changed to RP using an electronic ledger. RP may be C itself or a separate third party designee at time of creation in electronic form. Here, W is accessible and partially contained as software inside a mobile device, desktop, laptop or other computer or computational device.

In a typical eXFER funds are moved virtually out of B to an RPB or other bank due and payable by B to the other bank. In a tXFER, funds stay at B. The funds are moved virtually from A (an account at B) into a reserve account at B (RA). A second event is part of the tXFER: the moving (and optional immediately-prior creation) of an electronic representation of a certain number of promissory notes, (the singular of which being called “T”) from a “wallet” controlled by the Bank B to a wallet controlled by RP. (RP can be the same person as C.) T is also known as a token. The denomination of T is arbitrary, however, the value ascribed to a unit T should be such that the total number of T created and moved can express the value desired to be transferred.

The Promissory note, P, in its electronic form, is comprised of a series of TEL entries that also describe a total number of tokens, (nT)F, where the value of a token T is F/n, F is the total funds F described in P and n is a fixed number defining the value of a token relative to one unit of the currency the account A is in. (See example above) Each quantity of tokens, n times T (or nt), is a digital representation of the promise of bank, B, to pay that who controls the wallet containing the nT, one unit of physical currency, upon demand. Exercising that promise, causing the physical delivery of currency is called Redemption, R or burning B.

A typical embodiment of a “wallet” is a cryptocurrency wallet, where the value stored is any number of T. By definition, a promise P is “guaranteed by” the bank that issued it. Therefore, the tokens are collateralized by the bank's own ability to pay “upon demand” the underlying cash they represent.

When C demands payment, the promise in its electronic form may be destroyed or its Promisee may be transferred back B itself. Tokens, therefore, may be optionally destroyed or stored electronically in a reserve wallet controlled by B. Either action can be called the Redemption event R and correspond to a special ATM withdrawal of F or with a transfer of F into a bank account of C. In a redemption event, C as Promisee is transferred to B. This is a special case where C can be B.

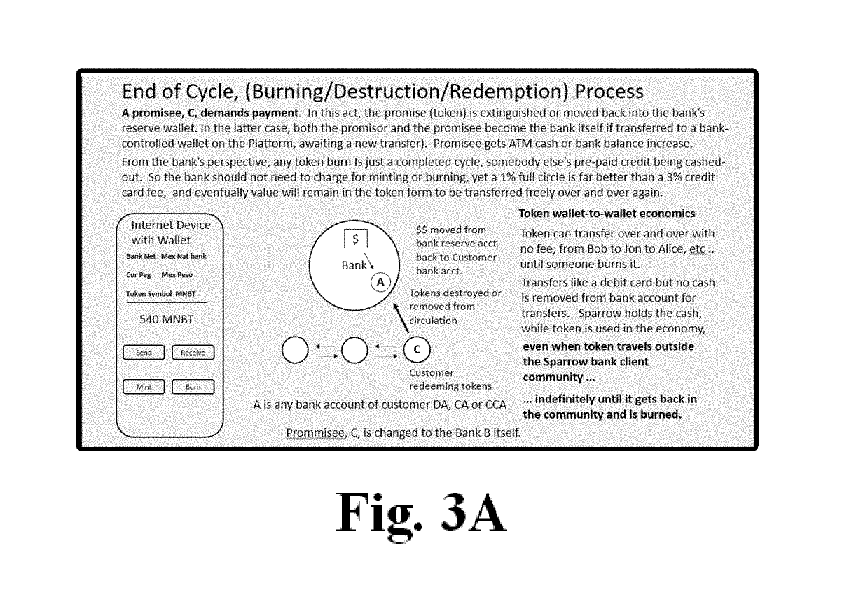

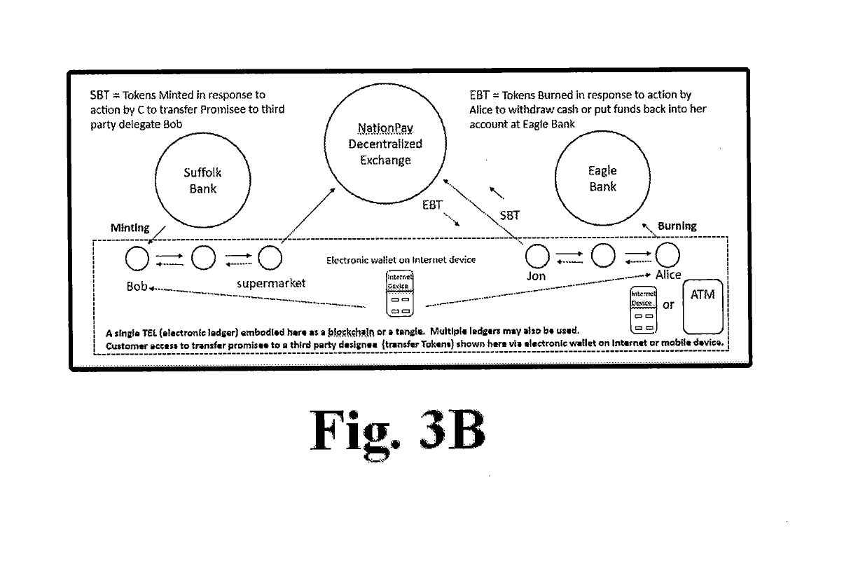

Referring to FIG. 3A, a redemption event that corresponds to an ATM withdrawal must be accompanied by a series of electronic ledger events that destroy P or otherwise transfer the Promisee, C back to the bank itself.

A Promise can be divided into fractional promises and stored electronically as such.

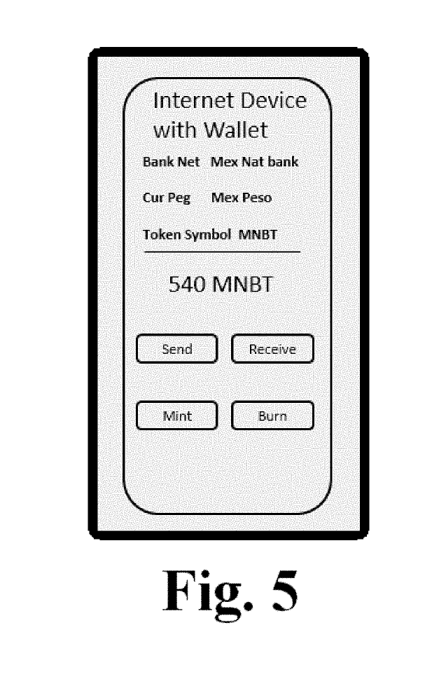

C in a promise, P, can be swapped with C in a different promise Pn, where the bank B of Pn (Bn) is different than bank B. To achieve this, an exchange is proposed to allow for the swapping or trading of Promisees. It is affected by the trading of tokens T and embodied in FIG. 5A.

Referring to FIG. 3B, the entire tXFER Flow showing token life cycle, showing, the Minting, multiple transfers according to multiple transfers of the Promisee, possible exchange activity and the eventual Redemption event. Tokens issued by different banks may be recorded on different TELs or one TEL as in the figure. In this embodiment, Bob presses the Mint button on mobile device. Alice trades for EBT and them presses the Burn button on her device.

### Special Subsets and Circumstances

Referring to FIG. 4, the Central Bank of any country and the Federal Reserve banks in the United States are also types of banks, B. Their customers are other member banks, (MBs) typically commercial banks. The accounts of each MB may be viewed as line of credit accounts, CA. however, the CA of a member bank are distinct in that not all the terms of the credit are defined upon the opening of the account and may change upon the result of an auction after which their account is funded. This does not change the promise, P, as defined in this patent. Because we define the promise such that any payback terms are in a separate agreement, the PAX. Therefore, Promisees between these banks may be transferred as disclosed in this patent.

Previous to now a bank has been defined by what we know a bank to be. Hereafter we add to that definition, any entity with an internal electronic ledger of accounts or any entity with a special relationship with an existing bank where that entity controls the outflow of monies from certain accounts within it that pertain to its customers. An example of such an entity is a credit card company. The customers, C, of a CCC are its member banks. When B is a credit card company (CCC), it is represented by a set of internal ledgers with accounts that are owned by member banks. The actual bank that handles these ledgers on behalf of the CCC is irrelevant because the CCC controls the funds as an ordinary bank would on behalf of its member banks. When a person makes a CCA purchase, the CCC funds that purchase using funds supplied from one of its customers CA accounts. As an example, C can be Barclay's bank and the CCC can be Visa. The terms of repayment according to a PAX are irrelevant. The 3^{rd} party designee is the receiving bank belonging to the merchant pertaining to where the CCA purchase was made.

In order to initiate the creation of an electronic promise which converts a promise P into an electronic form where its Promisee can be transferred, a device with software that is linked both internally to the electronic ledger of the bank B and to a TEL and for which a customer C has access, is claimed. Such device may be embodied by a mobile device with a specific application. It will have features to both Mint and Burn and it might look like the mobile device shown in FIG. 5.

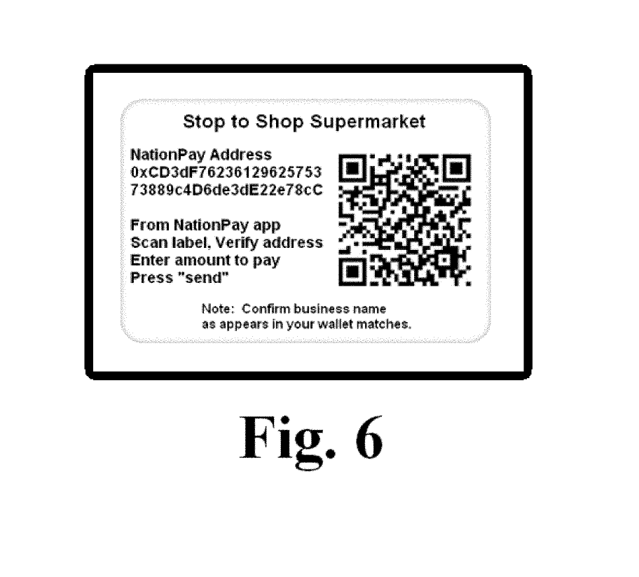

The ability to quickly provide to the system, a certain detail of the promise P, specifically, the third party designee, RP may be achieved through the use of a QR code (see FIG. 6). A preferred embodiment involves the merchant making available a QR code in some form which uniquely represents its wallet address and whereby the application in the prior claim might be used to scan that code so that an RP may be entered.

Preferred Embodiment where cooperation for KYC regulation only is implemented. Electronic Ledger is a blockchain ledger which also records the KYC information of all customers using it. Such recording may be provided as a feature to the ledger itself or access may be restricted to customers at participating banks only.

NationPay Wallet types (Roles)
Zone 1 and phase 1: (when Nation controls, Central Bank Partner, Central Bank is bank, banks are MSBs)

| | |
|---|---|
| Wallet role | |
| BankNet | (central bank owned) [the only real bank, according to role] |
| MSB | (commercial bank owned) [commercial banks are classed as MSBs] |
| MSBChild | (temp internal account at central bank mapping to the MSB fiat account) |
| AnySmartPhone | (banked or unbanked with a smart phone) |
| Custodial | (No smart phone. Present public key, pin and full name to MSB to receive) |
| ATM | |

Zone 2 and phase 2: (Direct Commercial Bank partners, commercial banks are banks, most users banked, all with
smartphone) Facilitates regional coin, like for Africa a union of countries and banks in an open way.

| | |
|---|---|
| Wallet role | |
| BankNet | (commercial bank owned) |
| Client of Bank | (banked, can be an MSB or just a regular person, unbanked supported) |
| Client Internal | (temp wallet if client is returning tokens for fiat into his bank account) |
| ATM | |

NationPay Software supports both relationships. Regional and world financial unity is supported.
The Gambia Pay system is universally compatible with NationPay network, interoperable without
friction between all banks using the network but never dependent on any bank's adoption.

A credit transaction as it exists today: a reversible promise is established between the client's bank (providing the credit) and the merchant, while another reversible promise is established between the bank and the purchaser. At some later date, actual value is transferred to merchant which nullifies or destroys promise #2. This process (known to those versed in the art) is called “settlement” and requires a third party settlement processor. At no time is the Promisee in promise #2 transferable to another party. More importantly, the promise (2) is reversible should one or more parties to the transaction attempt to dispute it. The promise requires separate settlement action to convert into a value transfer.

Order of Events:
1) Client purchases with credit card
2) Promise is established between bank and merchant
3) Promise is established between purchaser and bank
4) Later a payment processor “clears” payment. Bank must release actual funds to merchant and promise is destroyed.

Reversible Promise has 3 parts
a) The Promisor (bank promises)
b) The Promisee
c) The amount of value promised

In a typical credit transaction, promises are created. Much later, in separate transactions, the promises are destroyed and the value is transferred using a payment processor or clearing house to “settle” the payment. We present a vehicle where promises can be made that are irreversible, and can be treated like real value instantly without waiting for settlement. Further in the invention, the Promisee of an existing promise is transferable instantly—eliminating the need to create new promises.

The invention: Because the reversible promise cannot be transferred, the merchant cannot trade that promise for goods or services. The invention allows for the Promisee of any promise (promise 2 in this example) to be instantly transferable. In our example, Promise 2 is first made with purchaser and then is transferred to be the merchant. Promise 1 remains a traditional promise as in the existing system prior to this invention.

Promise has 3 parts
a) The Promisor (bank promises)
b) The Promisee
c) The amount of value promised

In a typical credit transaction, promises are created. Much later, in separate transactions, the promises are destroyed and the value is transferred using a payment processor or clearing house to “settle” the payment. We present a vehicle where for a given credit transaction, the Promisee of an existing promise is transferable instantly—instead of creating the promise, (2).

Token=A promise where the Promisee may be transferred by the current Promisee. The Promisor guarantees the value behind the promise with real currency.

1) Client receives tokens from the bank through his mobile device (tokens (promises) are issued or already exist where the Promisee is the Promisor. That means the tokens could already exist in the bank's own reserve account. Then, they are given to purchaser (Promisee is changed to purchaser)

2) The Tokens are transferred to the merchant (Promisee is changed to merchant)

3) Promise is established between bank and merchant

4) Promise is established between purchaser and bank

5) Later payment processor confirms, “clears” payment

6) By releasing actual funds to merchant, and promise is destroyed.

The mobile wallet allows purchasing by the current Promisee to scan a QR code on a cash register that represents the wallet of the merchant, who will become the new Promisee after the current Promisee scans the QR code. That changing of the Promisee is, by definition, the transfer of tokens.

Tokens that are backed by different currencies from different banks can be exchanged through a decentralized marketplace or exchange on the same platform.

### End of Cycle

A Promisee demands payment. In this act, the promise (token) is extinguished or moved back into the bank's reserve wallet. In the latter case, both the Promisor and the Promisee become the bank itself if transferred to a bank-controlled wallet on the Platform, awaiting a new transfer). Promisee gets ATM cash or bank balance increase. From the bank's perspective, any token burn is just a completed cycle, somebody else's pre-paid credit being cashed-out. So the bank should not need to charge for minting or burning, yet a 1% full circle is far better than a 3% credit card fee, and eventually value will remain in the token form to be transferred freely over and over again.

What is claimed is:

1. A method for electronically transferring value from a bank debit account, bank direct line of credit account or bank credit card account comprising the steps of:
establishing a promise between a bank of origin and a customer wherein the promise represents an obligation of the bank to pay all or a portion of a balance of funds owned by the customer and stored in at least one account of the customer at the bank of origin;
creating an electronic representation of the promise using a electronic computer device on an electronic platform;
transferring the promise from the customer, as the first Promisee, to a third party Promisee; and
wherein the funds represented by the promise are retained by the bank of origin.

2. The method as recited in claim 1 wherein the step of creating an electronic representation of the promise includes issuing at least one digital token representing the promise.

3. The method as recited in claim 2 further comprising the step of:
destroying the promise upon redemption of the value associated with the promise.

4. The method as recited in claim 3 wherein the step of destroying the promise includes transferring the promise back to the bank of origin wherein the bank of origin becomes the Promisee.

5. The method as recited in claim 1 wherein the promise can be divided into fractional promises and stored electronically, and the fractional promises can be transferred by the customer to one or more third party Promisees.

6. The method as recited in claim 1 wherein the Promisee can be swapped with another Promisee in a different promise established with a different bank.

7. The method as recited in claim 1 further comprising the steps of:
establishing a second promise between the bank of origin and the customer wherein the second promise represents an obligation of the customer to repay funds to the bank of origin; and
transferring the second promise from the customer, as the first Promisor, to a third party Promisor.

8. The method as recited in claim 1 wherein the electronic computer device is a mobile device.

9. The method as recited in claim 1 wherein the electronic platform includes at least one electronic ledger.
